(19) United States
(12) Patent Application Publication
(10) Pub. No.: US 2010/0166214 A1
(43) Pub. Date: Jul. 1, 2010

(54) ELECTRICAL APPARATUS, AUDIO-RECEIVING CIRCUIT AND METHOD FOR FILTERING NOISE

(75) Inventors: Hsin-Li Lee, Hsinchu County (TW); Gee-Pinn Too, Tainan (TW); Yu-Hao Hsieh, Taipei City (TW); Chih-Hao Chou, Taichung City (TW); Bo-Hsien Wu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: INDUSTRIAL TECHNOLOGY RESEARCH INSTITUTE, Hsinchu (TW); NCKU RESEARCH & DEVELOPMENT FOUNDATION, Tainan (TW)

(21) Appl. No.: 12/480,695

(22) Filed: Jun. 9, 2009

(30) Foreign Application Priority Data
Dec. 30, 2008 (TW) 97151417

(51) Int. Cl. H04B 15/00

(52) U.S. Cl. 381/94.1

(57) ABSTRACT

An electronic apparatus at least including an audio-receiving circuit is provided. The audio-receiving circuit includes an audio receiver and a processor. The audio receiver receives a sound wave from a sound source, and generates a first audio signal containing a plurality of noises to the processor. The processor performs a signal processing of time reversal to the first audio signal to restore a sound sent at an original sound source, so as to filter noises in the first audio signal and output a second audio signal.

### CROSS-REFERENCE TO RELATED APPLICATION

This application claims the priority benefit of Taiwan application serial no. 97151417, filed on Dec. 30, 2008. The entirety of the above-mentioned patent application is hereby incorporated by reference herein and made a part of specification.

### BACKGROUND

1. Technical Field

The present disclosure relates to an electronic apparatus. More particularly, the present disclosure relates to an audio-receiving circuit and a method for filtering noises.

2. Description of Related Art

With a quick development of semiconductor fabrication processes, and a progress of a wireless communication technique, a remote communication media for connecting people is not limited to a conventional cable telephone. Since a mobile phone has advantages of high mobility, high convenience and powerful functions, etc, it gradually substitutes the conventional cable phone under efforts of practitioner.

Moreover, since a popularity of the Internet is increased, and Internet techniques become mature, Internet phones that can implement the communication through the Internet are also developed. Since a phone call performed through the Internet has a very low cost, and multi-connection of the phone call can be achieved, the Internet phone becomes another option for a plurality of users. Accordingly, the communication devices are gradually popularised to personal computers, laptop computers and personal digital assistants (PDA), etc.

However, regardless of the phone call being performed through the conventional cable phone or the present mobile phone and the Internet phone, a following problem is inevitable. When one of the users is in a very noisy environment, the other user is hard to clearly hear a voice from the phone. Therefore, not only utilization thereof is inconvenient, but also important messages can be missed, which can lead to an irreparable loss. Accordingly, how to filter the environment noises is always an essential subject in remote communication.

Actually, a noise-filtering technique is not only required by the remote communication, but is also required in a plurality of domains. For example, a human-ear hearing aid or a voice-controlled system, etc., all requires accurately capturing a sound wave sent from a sound source, and filtering the environmental noises.

Presently, a commonly used noise-filtering method is to filter unnecessary voices via signal processing, such as high-pass filtering or low-pass filtering, etc., after the sound signal is received. However, such method is only adapted to an environment having a pure noise. For example, assuming a motor is operated and sends noises during a phone call, such noise can be easily filtered via the high-pass filtering. However, in an actual environment, the frequency of noise is random, and the frequency can be high and low, and even can be closed to a frequency of the sound wave sent from the target sound source.

### SUMMARY

The present disclosure provides an audio-receiving circuit including an audio receiver and a processor. The audio receiver receives a sound wave from a sound source, and generates a first audio signal, containing a plurality of noises, to the processor. The processor performs a signal processing of time reversal to the first audio signal, so as to filter noises in the first audio signal and output a second audio signal.

The present disclosure provides an electronic apparatus including an audio receiving module, a processor and an output module. The audio receiving module includes a plurality of audio receivers, and is used for receiving a sound wave from a sound source, and respectively outputting a plurality of first audio signals, containing a plurality of noises, to the processor. The processor performs a time reversal operation to the first audio signal, so as to restore a sound sent from an original sound source, and filter noises in the first audio signal to output a second audio signal. By such means, the output module can output the second audio signal.

The present disclosure further provides a method for filtering noises. The method can be described as follows. First, a plurality of audio-receiving sources is used for receiving a sound wave from a sound source, and generating a plurality of first audio signals containing a plurality of noises. Next, a time reversal operation is respectively performed to the first audio signals to obtain a plurality of first time reversal signals. Next, a convolution integral operation is respectively performed to each of the first time reversal signals and one of a plurality of corresponding path impulse response functions, so as to filter noises in the first audio signals and obtain a plurality of second time reversal signals.

### BRIEF DESCRIPTION OF THE DRAWINGS

The accompanying drawings are included to provide a further understanding of the disclosure, and are incorporated in and constitute a part of this specification. The drawings illustrate exemplary embodiments and, together with the description, serve to explain the principles of the disclosure.

FIG. 1 is a circuit block diagram illustrating an audio-receiving circuit according to a exemplary embodiment.

FIG. 2 is a system block diagram illustrating a processor according to an exemplary embodiment.

FIG. 3 is a system block diagram illustrating an electronic apparatus according to a exemplary embodiment.

FIG. 4 is a system block diagram illustrating a processor according to another exemplary embodiment.

FIG. 5 is a flowchart illustrating a method for filtering noises according to an exemplary embodiment.

### DETAILED DESCRIPTION

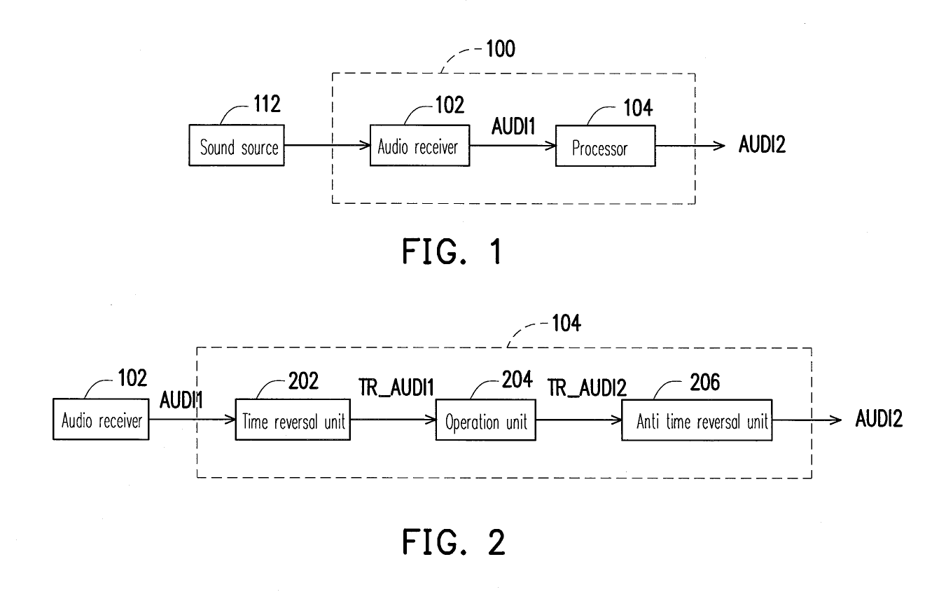

FIG. 1 is a circuit block diagram illustrating an audio-receiving circuit according to an exemplary embodiment. Referring to FIG. 1, the audio-receiving circuit 100 includes an audio receiver 102 and a processor 104. The audio receiver 102 can be implemented by a microphone (for example, a capacitive microphone), which can receive a sound wave generated by a sound source 112, and output a first audio signal AUDI1.

The processor 104 is coupled to the audio receiver 102, and receives the first audio signal AUDI1. Since when the audio receiver 102 receives the sound wave from the sound source 112, other sound waves are probably transmitted in the environment as well, so that the first audio signal AUDI1 probably contains a plurality of noises. Therefore, the processor 104 performs a time reversal operation to the first audio signal AUDI1 to filter the noises.

FIG. 2 is a system block diagram illustrating a processor according to an exemplary embodiment. Referring to FIG. 2, the processor 104 includes a time reversal unit 202, an operation unit 204 and an anti time reversal unit 206. The time reversal unit 202 is coupled to the audio receiver 102 and the operation unit 204. Moreover, the operation unit 204 is coupled to the anti time reversal unit 206.

When the first audio signal AUDI1 output by the audio receiver 102 is transmitted to the processor 104, the time reversal unit 202 first performs the time reversal operation to the first audio signal AUDI1. The so-called time reversal operation represents that a waveform of the first audio signal AUDI1 in a time domain is reversed according to a time sequence. Now, the time reversal unit 202 outputs a first time reversal signal TR_AUDI1 to the operation unit 204. The operation unit 204 performs a convolution integral operation to the first time reversal signal and a predetermined path impulse response function, and outputs a second time reversal signal TR-AUDI2.

When a specific sound wave is transmitted in a space, it has a specific path impulse response function. When other noises are transmitted in the same space, they do not match the specific path impulse response function. Therefore, when the convolution integral operation is performed to the time reversal signal TR_AUDI1 and the specific path impulse response function, the other noises can be filtered. Though the noises in the time reversal signal TR_AUDI2 are filtered, since the time reversal operation is performed to the audio signal, a content thereof cannot be recognized by a user. Therefore, in the present exemplary embodiment, the operation unit 204 further outputs the second time reversal signal TR_AUDI2 to the anti time reversal unit 206 to perform time reversal operation, and output a second audio signal AUDI2 that can be recognized by the user.

Since the above circuit can filter the noises in the audio signal, the present disclosure can further be applied to some electronic apparatus for receiving the sound wave from the sound source, so as to reduce a distortion of an output audio signal.

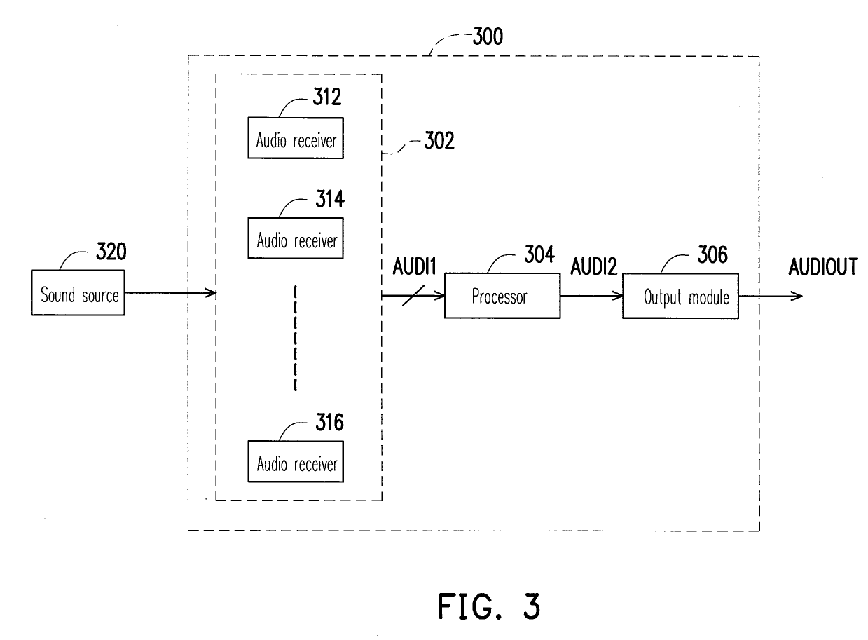

FIG. 3 is a system block diagram illustrating an electronic apparatus according to a exemplary embodiment. Referring to FIG. 3, the electronic apparatus 300 of the present exemplary embodiment can be a mobile phone, a computer system, a PDA, a sound-controlled device, a hearing aid or an Internet phone system, etc. In the present exemplary embodiment, the electronic apparatus 300 receives a sound wave from a sound source 320, and filters the environmental noises via the time reversal operation, so as to output an output audio signal AUDIOUT. The electronic apparatus 300 of the present exemplary embodiment includes an audio-receiving module 302, a processor 304 and an output module 306. Wherein, the audio-receiving module 302 is coupled to the processor 304, and the processor 304 is coupled to the output module 306.

In the electronic apparatus 300, the audio-receiving module 302 includes at least one audio-receiving unit. However, since noises can be generated in a system of the electronic apparatus 300, the quality of the output audio signal AUDIOUT output by the electronic device 300 can be decreased. Accordingly, to minimize the noises in the system, the audio-receiving module 302 may includes a plurality of audio receivers 312, 314 and 316, wherein the audio receivers can be implemented by microphones such as capacitive microphones, etc. Moreover, in some embodiments, the audio receivers can be in array to form an audio receiver (microphone) array.

Similar to the audio receiver 102 of FIG. 1, the audio receivers 312, 314 and 316 can also receive the sound wave from the sound source 320, and convert it into a plurality of first audio signals AUDI1 to the processor 304. Similarly, the processor 304 also performs the time reversal operation to the first audio signals AUDI1 to filter the noises therein.

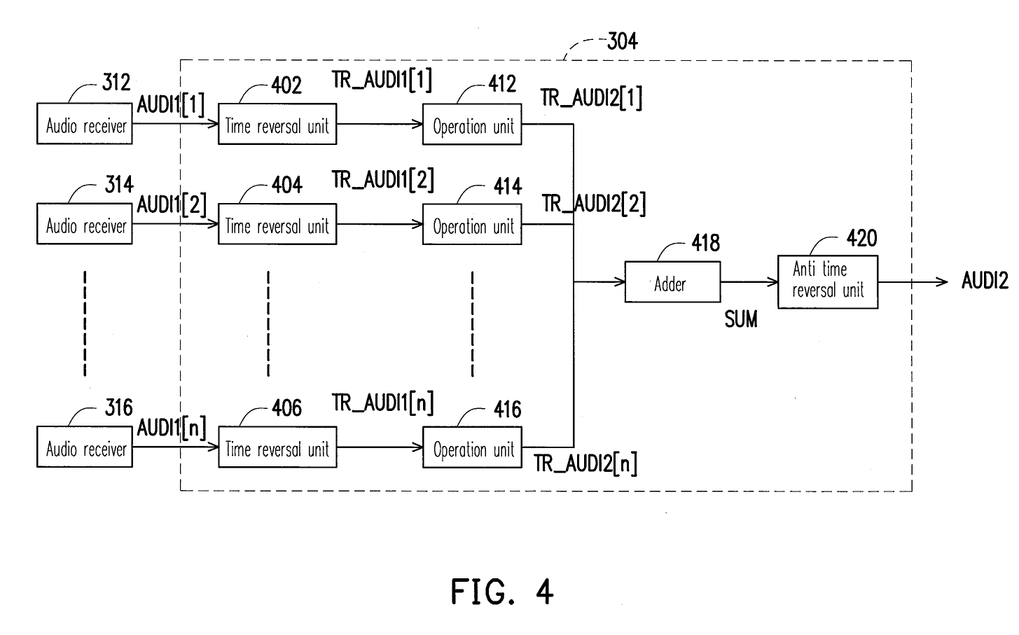

Since the audio-receiving module 302 includes a plurality of the audio receivers, a circuit structure of the processor 304 is different to that of the processor 104 of FIG. 2. FIG. 4 is a system block diagram illustrating a processor according to another exemplary embodiment. Referring to FIG. 4, the processor 304 includes a plurality of time reversal units 402, 404 and 406 respectively coupled to the corresponding audio receivers 312, 314 and 316. Moreover, the processor 304 can include a plurality of operation units 412, 414 and 416 respectively coupled to the corresponding time reversal unit. In addition, the processor 304 can further include an adder 418 coupled to all of the operation units. Moreover, the adder 418 is coupled to an anti time reversal unit 420.

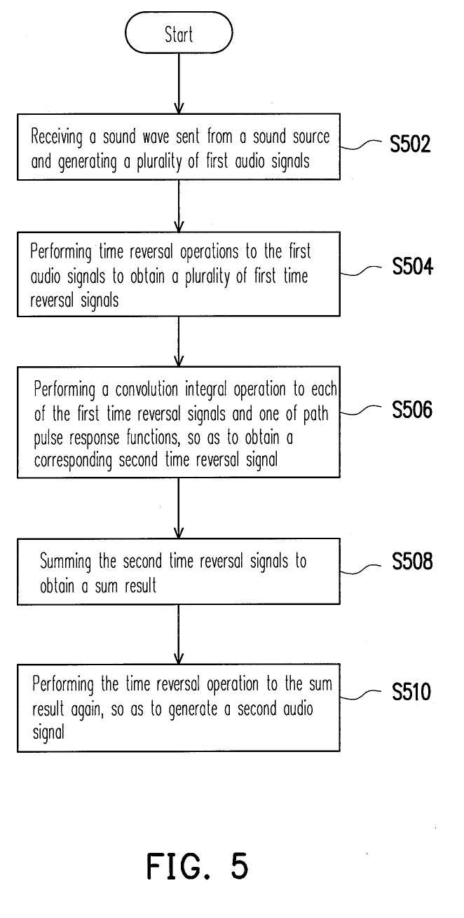

FIG. 5 is a flowchart illustrating a method for filtering noises according to an exemplary embodiment. Referring to FIG. 4 and FIG. 5, in step S502, the audio receivers 312, 314 and 316 respectively receive the sound wave from the sound source 112, and generate a plurality of first audio signals AUDI1[1:n]. In step S504, the time reversal units 402, 404 and 406 respectively perform the time reversal operation to the corresponding first audio signal AUDI1, so as to generate a plurality of first time reversal signals TR_AUDI1[1:n].

Moreover, the time reversal units 402, 404 and 406 respectively transmit the first time reversal signals TR_AUDI1[1:n] to the corresponding operation unit. Next, in step S506, a convolution integral operation is respectively performed to each of the first time reversal signals TR_AUDI1[1:] and a corresponding path impulse response function, so that each of the operation units can generate a corresponding second time reversal signal TR_AUDI2[1:n]. Next, in step S508, the adder 418 receives and sums all of the second time reversal signals TR_AUDI2[1:n] to output a sum result SUM to the anti time reversal unit 420. Next, in step S510, the anti time reversal unit 420 performs time reversal operation to the sum result SUM again, so as to restore a sound sent from the original sound source 112, and output the second audio signal AUDI2.

Referring to FIG. 3 again, the second audio signal AUDI2 can be transmitted to the output module 306. In some other embodiments, the output module 306 can be a speaker. Therefore, the output module 306 can play the second audio signal AUDI2 to generate the output audio signal AUDIOUT. In some other embodiments, the output module 306 can further transmit the second audio signal AUDI2 through a transmission interface, wherein the transmission interface can be a phone network, the Internet or a local area network (LAN), etc.

In summary, in the present disclosure, since the time reversal operation is performed to the audio signal, and the convolution integral operation is performed to the time reversal signal and the corresponding path impulse response function, the noises in the audio signal can be effectively eliminated. Moreover, the time reversal operation can be performed to the noise-filtered audio signal for the second time, so as to restore the original sound.

It will be apparent to those skilled in the art that various modifications and variations can be made to the structure of the present disclosure without departing from the scope or spirit of the invention. In view of the foregoing, it is intended that the present disclosure cover modifications and variations of this disclosure provided they fall within the scope of the following claims and their equivalents.

What is claimed is:

1. An audio-receiving circuit, at least comprising:
an audio receiver, receiving a sound wave from a sound source, and generating a first audio signal containing a plurality of noises; and
a processor, coupled to the audio receiver, for performing a signal processing of time reversal to the first audio signal to restore a sound sent from an original sound source, to filter the plurality of noises in the first audio signal and output a second audio signal.

2. The audio-receiving circuit as claimed in claim 1, wherein the processor comprises:
a time reversal unit, coupled to the audio receiver, for performing a time reversal operation to the first audio signal, to obtain a first time reversal signal;
an operation unit, coupled to the time reversal unit, for performing a convolution integral operation to the first time reversal signal and a path impulse response function, to obtain a second time reversal signal; and
an anti time reversal unit, performing time reversal operation to the second time reversal signal, to obtain the second audio signal.

3. The audio-receiving circuit as claimed in claim 1, wherein the audio receiver is a capacitive microphone.

4. An electronic apparatus, comprising:
an audio receiving module, having a plurality of audio receivers, for receiving a sound wave from a sound source, and respectively outputting a plurality of first audio signals containing a plurality of noises;
a processor, coupled to the audio receivers, for performing a time reversal operation to the first audio signals, to filter the plurality of noises in the first audio signal and output a second audio signal; and
an output module, coupled to the processor, for outputting the second audio signal.

5. The electronic apparatus as claimed in claim 4, wherein the processor comprising:
a plurality of time reversal units, respectively coupled to the audio receivers, for performing the time reversal operation to the first audio signals, to obtain a plurality of first time reversal signals;
a plurality of operation units, respectively coupled to the time reversal units, for performing a convolution integral operation to each of the first time reversal signals and one of a plurality of path impulse response functions, to obtain a plurality of second time reversal signals;
an adder, coupled to the operation units, for summing the second time reversal signals; and
an anti time reversal unit, coupled to the adder, for performing time reversal operation to summed second time reversal signals, to obtain the second audio signal.

6. The electronic apparatus as claimed in claim 5, wherein each of the path impulse response functions corresponds to one of the audio receivers, and each of the path impulse response functions is determined according to a position of the corresponding audio receiver.

7. The electronic apparatus as claimed in claim 4, wherein the audio receivers are in array.

8. The electronic apparatus as claimed in claim 4, wherein the audio receivers are respectively a microphone.

9. The electronic apparatus as claimed in claim 8, wherein the microphones are respectively a capacitive microphones.

10. The electronic apparatus as claimed in claim 4, wherein the output module is a speaker used for playing the second audio signal.

11. The electronic apparatus as claimed in claim 4, wherein the output module is used for transmitting the second audio signal through a transmission interface.

12. The electronic apparatus as claimed in claim 11, wherein the transmission interface comprises a phone network, the Internet and a local area network (LAN).

13. A method for filtering noises, comprising:
receiving a sound wave from a sound source through a plurality of audio-receiving sources, and generating a plurality of first audio signals containing a plurality of noises;
performing time reversal operations to the first audio signals to obtain a plurality of first time reversal signals; and
performing a convolution integral operation to each of the first time reversal signals and one of a plurality of path impulse response functions, to filter the plurality of noises in the first audio signals and obtain a corresponding second time reversal signal.

14. The method for filtering noises as claimed in claim 13, further comprising:
summing the second time reversal signals to obtain a sum result; and
performing a time reversal operation to the sum result, to restore a sound sent from the sound source.

15. The method for filtering noises as claimed in claim 13, wherein each of the path impulse response functions is determined according to a relative position between the corresponding audio-receiving source and the sound source.
